(19) United States
(12) Patent Application Publication
(10) Pub. No.: US 2008/0229200 A1
(43) Pub. Date: Sep. 18, 2008

(54) Graphical Digital Audio Data Processing System

(76) Inventors: Gene S. Fein, Lenox, MA (US); Edward Merritt, Lenox, MA (US)

Correspondence Address: Stolowitz Ford Cowger LLP, 621 SW Morrison St, Suite 600, Portland, OR, 97205, US

(21) Appl. No.: 11/687,077

(22) Filed: Mar. 16, 2007

(51) Int. Cl. G06F 3/00

(52) U.S. Cl. 715/716; 715/722

(57) ABSTRACT

In this editing and mixing environment, the graphical form is a direct and exact model of the audio recording. Thus, there is a one-to-one relationship between the manipulation of an audio recording, via manipulation of the graphical form, and the resulting edited audio recording. The audio editing system relates audio to a visual graphical form by providing a tactile dimensionality and functionality to translate the form into an edit and/or mixing audio process and result. In this manner, a user may not only hear the representation of the music that has been edited or mixed, but may also see the representation of the audio in representative graphical form. The form may be manipulated by a user in logical scale to the sound so that the user may learn the traits and tools of the editing system.

### BACKGROUND OF THE INVENTION

Recently, the audio recording industry has gone through a transformation as digital technology has helped to reduce the cost of professional quality recording production. Mixing consoles and equipment that previously cost a half-million dollars can now be duplicated for one tenth of that amount. The result is millions of home studios across the world, mostly running high-end capture, editing and mixing programs or computer-based systems. Large recording studios still exist, but they have become more useful for space and privacy than for the actual expensive mixing boards that are employed within them.

Open source digital audio systems for the computer have also become professional quality with the advent of the Advanced Linux Sound Architecture (ALSA) and the Linux low latency kernel patch, which allow the GNU/Linux Operating System to achieve audio processing performance equal to that of commercial operating systems. The multi-platform package Audacity is currently the most fully-featured free software audio editor.

Conventional models of recording are still translatable, within reason, from the studio method of recording, engineering and mixing, to the home studio or computer-based recording experience. In both situations, the audio engineer adjusts levels of the recorded audio, during both the recording process and the mixing process, to yield the audio in the finished product desired by the engineer and/or his clients.

It is well known that studio production of digital audio recordings follows a certain process where audio is recorded through microphones or other means, such as direct patching of an electronic or amplified instrument to recording equipment. Typical recording of music or audio, in general, calls for recording of sounds such as vocals, percussion, bass, guitar, turntables, sampled audio clips and numerous Foley sounds, all for the purpose of recording and forming a desired track and, ultimately, a completed composition. These recordings may be stored on individual tracks, which may be then stored in a hard drive or other storage system, including tape or flash memory. The stored master recordings are then isolated and mixed both individually and collectively to yield a final composition via input to a mixing console, such as a Mackie X.200 series mixer, a Tascam DM-4800, or any number of other digital mixing boards; or via a sound mixing and editing on a computer system using a program such as Pro Tools.

The recording engineer may then manipulate the audio tracks by using various effects and levels settings. Many controls are available to the engineer, such as volume level, high end frequency, low end frequency, bass, treble and delay. Further, a whole range of effects are available, such as layering or doubling, tripling or quadrupling a recorded track to hear a gentle or pronounced reinforcement of the track in the layering effect by separating the layering tracks in uniform or different degrees of time. These effects and levels settings alter the sound of the original recording based upon the manner and mode adjustments made by the engineer. The adjustment of levels by use of dials, buttons and mouse clicks (all similar methods) is the most common way that the sound of a single track, or of multiple tracks mixed together, is manipulated during the mixing process. The relationship of the controls to the sound is separated because the adjustment of the control then impacts the recording.

Unfortunately, the existing conventional uses have certain limitations. Specifically, there is no dynamic representation of the sound being edited, that can be directly manipulated by the engineer, to add a visual and tactile element to the engineering and mixing of sound recordings, where there is a one-to-one relationship created between how the visual rendering of the sound recording is represented and how that sound may be edited and altered using graphic tools to edit the physical, graphical and visual representation of the sound recording.

### SUMMARY OF THE INVENTION

Accordingly, there is a need for an audio editing system where graphical representations of audio track recordings can be manipulated with graphical editing tools. The present invention transforms audio editing and mixing into audio sculpting. The graphical digital audio system models sound as a graphically dimensional representation which may be graphically adjusted with tools that directly and logically impact the audio, based upon the specific manipulations of the graphical representation using those tools.

In this editing and mixing environment, the graphical form is a direct and exact model of the audio recording. Thus, there is a one-to-one relationship between the manipulation of an audio recording, via manipulation of the graphical form, and the resulting edited audio recording. The audio editing system relates audio to a visual graphical form by providing a tactile dimensionality and functionality to translate the form into an edit and/or mixing audio process and result. In this manner, a user may not only hear the representation of the music that has been edited or mixed, but also can see the representation of the audio in representative graphical form. The form may be manipulated by a user in logical scale to the sound so that the user may learn the traits and tools of the editing system.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an illustration of a digital audio editing work station.

FIGS. 2A-2B are illustrations of a graphical representation of an audio recording.

FIG. 3A is an illustration of a graphical representation of an audio recording, showing audio elements that may be edited.

FIG. 3B is an illustration of a graphical representation of an audio recording, encompassing multiple tracks of a musical composition and their respective elements.

FIG. 4A is an illustration of a graphical representation of an audio recording, showing manipulations represented by size and color.

FIG. 4B is an illustration of a graphical representation of an audio recording, showing manipulations represented by other characteristics.

FIG. 5 is an illustration of a toolbar for selecting editing tools.

FIGS. 6A-6P-2 are illustrations of graphical representations of an audio recording, showing editing tools in use.

### DETAILED DESCRIPTION OF THE INVENTION

A description of example embodiments of the invention follows.

### Processing Environment

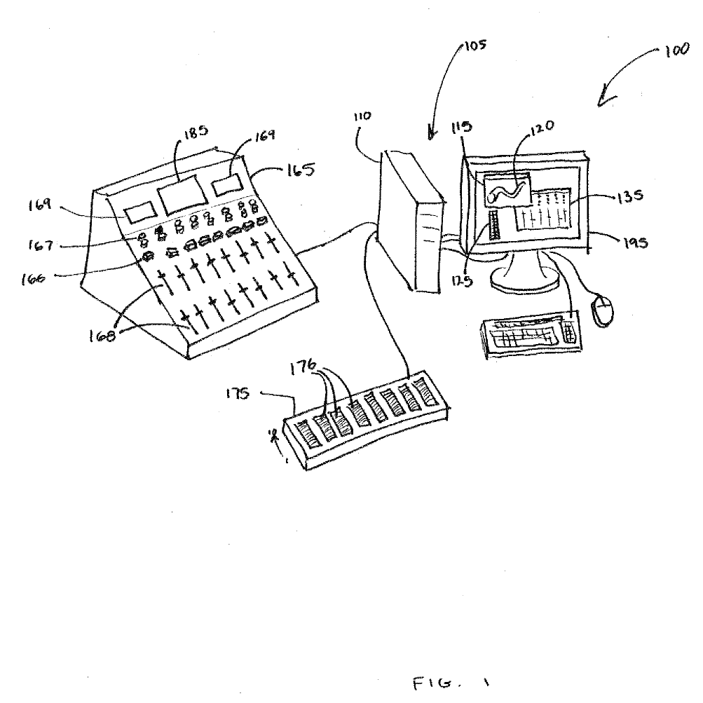

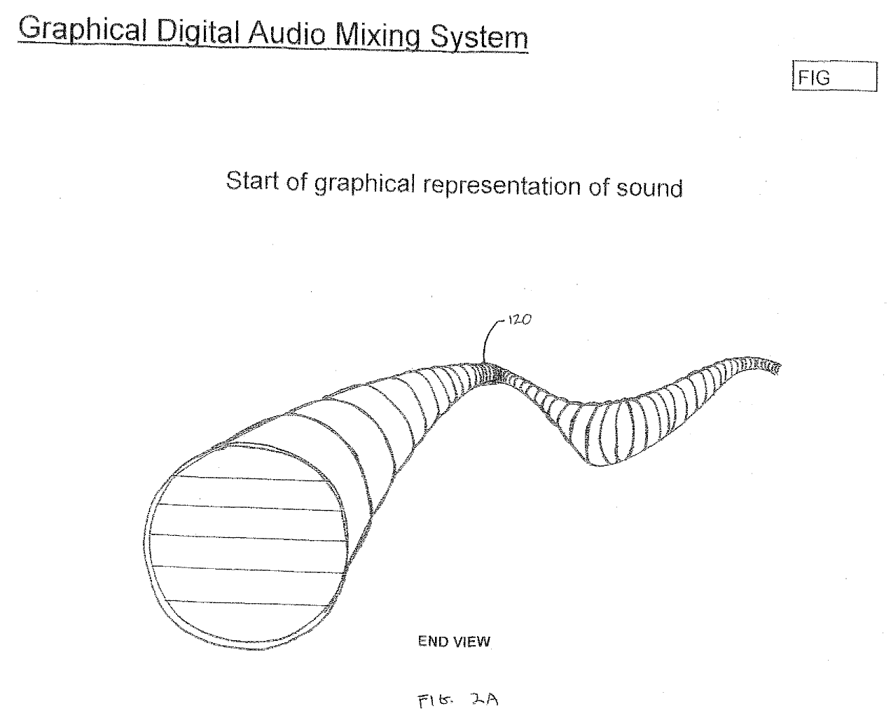

FIG. 1 illustrates a studio in which the graphical digital audio data processing system 100 of the present invention may be employed. In the studio, separate or mixed-together tracks are stored on an editing system 105 in hard drives, tape or other digital storage. Those tracks may be located, activated, accessed and manipulated by an editing program 115. They may be edited using a mixing board 165, console, or other interface.

The entire tracks may have been saved in graphical form from the time of recording, or may be exported to the modeling program in advance of editing or remixing, just as other data is commonly exported to other computer programs. In a live recording process, this information is processed in real-time, and may be processed by the fastest processors available to guard against delay.

### Audio Sculpting

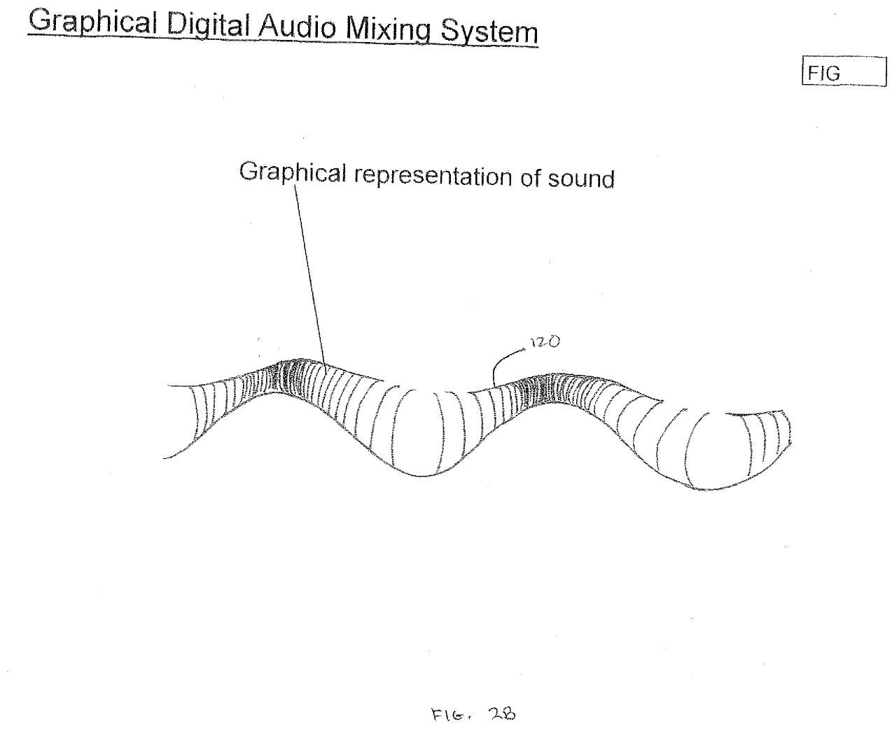

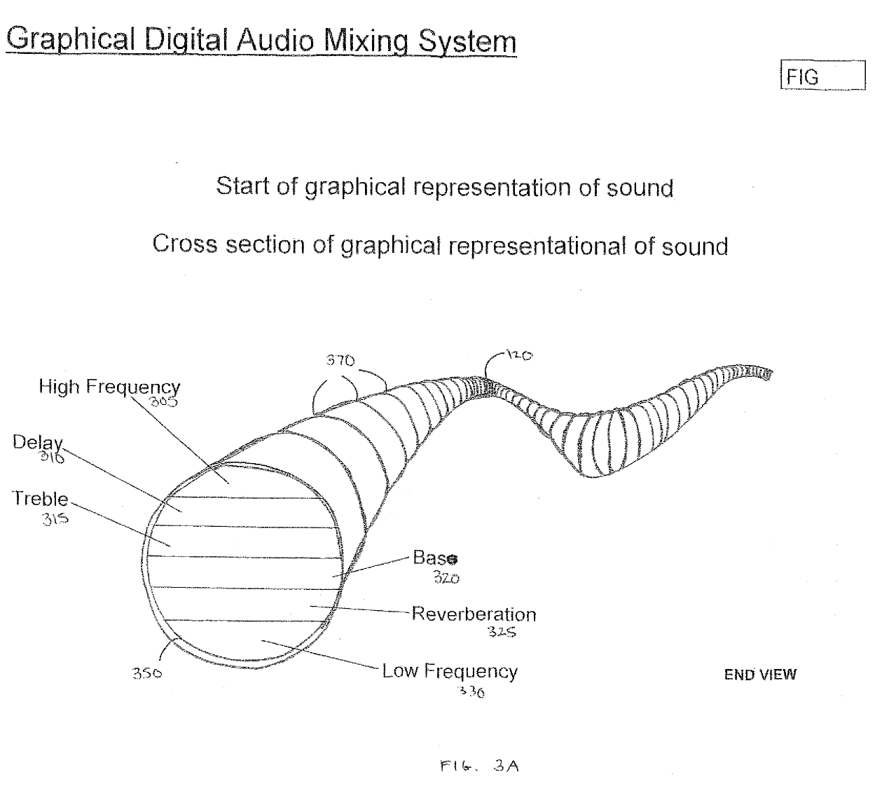

In accordance with one embodiment of the present invention, a digital audio data processing system 100 is provided wherein an audio recording is represented on a one-to-one basis as a graphical image 120. The graphical image 120, as illustrated in FIG. 2, may be manipulated in a process referred to herein as audio sculpting. In the process, the audio recording is modified by the manipulation of the of the image 120 with a series of digital graphical editing tools 125. The editor, producer, artist, or engineer, generally referred to herein as the user, may employ the tools to manipulate the image 120 in a way that yields the exact audio output desired by the user, or any other person with authority or control over the final recording.

The shape of the audio recording image 120 may be sculpted using traditional buttons 166, faders 168, and dials 167 on a mixing board 165 or console 175, and computer interface controls 135. In this case, the tool (buttons 166, dials 167, faders 168, or computer interface controls 135) chosen by the user dictates what actions and movements are to be made by the user (e.g., pushing, turning, sliding or clicking). This is referred to as indirect audio sculpting. By this process the user manipulates each of these tools to achieve the desired manipulation to the audio recording image 120, thereby achieving the desired manipulation of the recorded sound.

However, in a preferred embodiment, the edits performed on the recorded sound are activated by the user directly interacting with and reshaping the audio recording image 120 using a suite of simple tools 125. The user thereby alters the audio recording on a one-to-one basis with the audio recording image 120. In this case, the actions and manipulations made by the user (e.g., slicing, dragging, compressing, expanding) dictate what elements of the audio recording are manipulated. This is referred to as direct audio sculpting.

### Representation of Audio Data as a Graphical Image on a One-to-One Basis

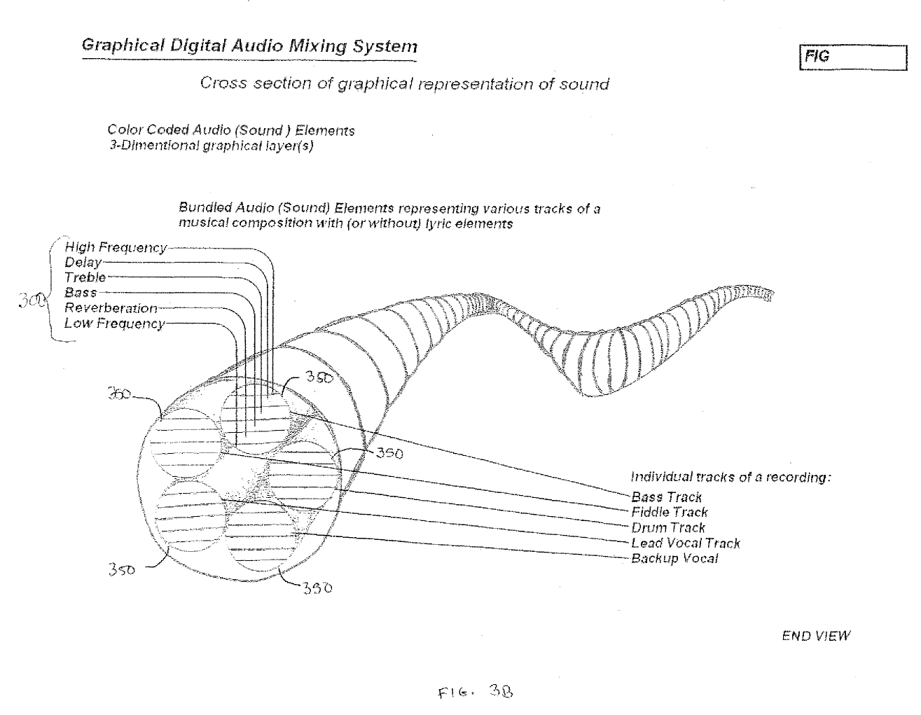

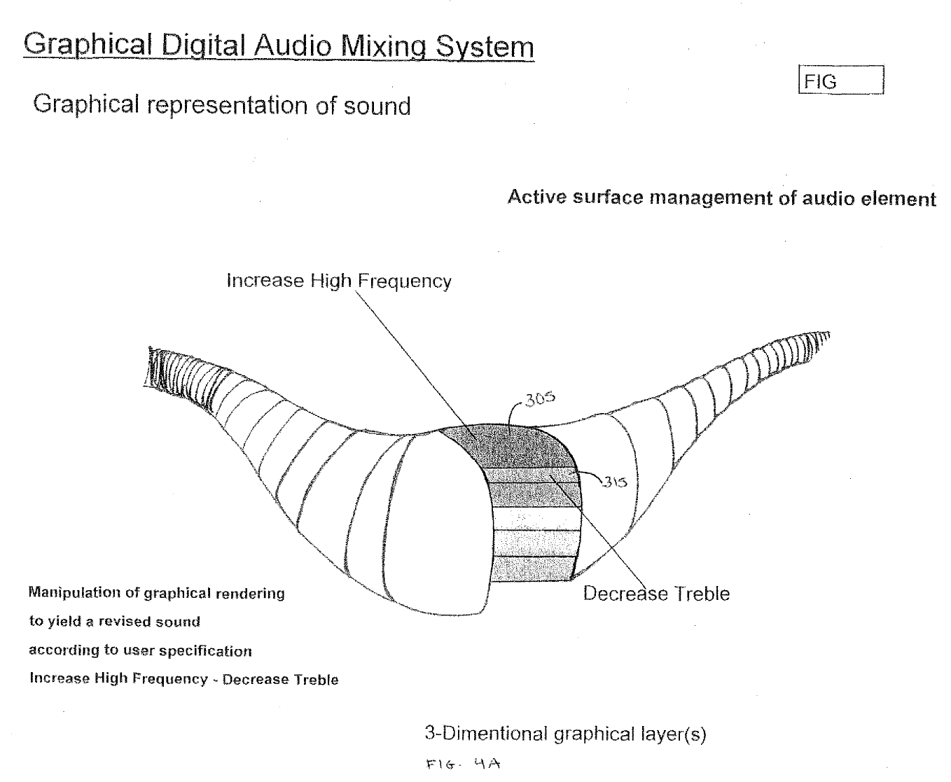

The audio recording image 120 is represented as illustrated in FIG. 3A. Overall audio level is represented as an all encompassing image 120. Here, that image 120 is a three-dimension representation that encompasses one track 350. The track 350 contains individual audio elements 300 such as high frequency 305, low frequency 330, bass 320, treble 315 and effects, such as delay 310, reverberation 325, distortion or graininess. Other effects include layering a single track over another track of the same recording (known as “doubling,” “tripling,” etc. of a track), frequently a vocal recording. Manipulation of that image 120 manipulates all encompassed sound elements 300. For instance, by expanding the entire graphical representation 120 of the track 350, the volume on every audio element 300 of the track 350 is raised uniformly.

Levels, which may be analog or digital levels, of each element 300 are read and established by the editing system 100 by reading the console data or imported audio data. The levels may be represented separately by a light readout or level readout on the console 175, a video screen 185 within sight of the console 175, or on a computer monitor 195, sometimes with more than one of these items displaying the levels simultaneously. Those levels may be indicated by light emitting diodes (LEDs) 176 or other lighted control board elements, usually represented by composites on a basic scale of 1 through 10. Other values, that may be much larger or smaller, representing audio elements such as volume level, are represented and may be manipulated by the buttons 166, dials 167, faders 168, gauges 169 and UI controls 135, such as mouse-based controls. Users may then look at the different control settings and, while listening to the audio recording, determine which settings may need to be manipulated in order to obtain a desired audio recording end product.

The analog or digital readout levels of each audio element 300, track or multitrack setting are then transformed by the system 100 into a graphical representation 120. This transformation may be at a sampling rate of 48,000 hz, or may be larger in the case of oversampling. The relation to the audio element 300 levels is subsequently displayed by the audio sculpting system 100 in a one-to-one manner which keeps the scale and relationship of each individual element 300.

The link between the graphical image 120 and the recording information is translated and communicated to the systems by programming elements. The audio sculpting program 115, which may be a custom Computer Animated Design program, may use form and color information from the graphical image 120 to replicate each manipulated or modified bit of data. The manipulations are fed back to the edit system 100, mixing console 175, or computer-based edit system 110 for processing of the audio recording. Because the audio is linked to the graphical representation 120 on a one-to-one basis, the manipulation of the image parameters results in a modification of the audio.

Multiple tracks 350, as illustrated in FIG. 3B, may be encompassed within the image 120 for mixing and sculpting. Further, single, mixed-down tracks may be manipulated for final output as a master to be deemed as finished or ready for an audio sweetening or mastering process. Both the sweetening and mastering processes may also utilize the audio sculpting process in the manner described herein.

Further, the audio recording is captured in units of time 370, at a frame-bit or microsecond level, as a near-perfect representation of the individual element 300 and group of sound elements. Transformation of audio elements 300 in different tracks 350 may be synchronized by a time code so that each audio track 350 is presented in a simultaneous synchronization to its brother or sister tracks 350 in a given composition 120. This time code may be a Society of Motion Picture and Television Engineers (SMPTE) code or other generation locked code to synchronize the disparate tracks 350 and inter-track audio elements 300.

### Manipulation of Individual Elements

In addition to manipulating the overall levels of the track 350 by manipulating the image 120, individual elements 300 may be manipulated within each track 350. Audio element data may be mapped according to and in relation to the exact readings of the levels of each sound element.

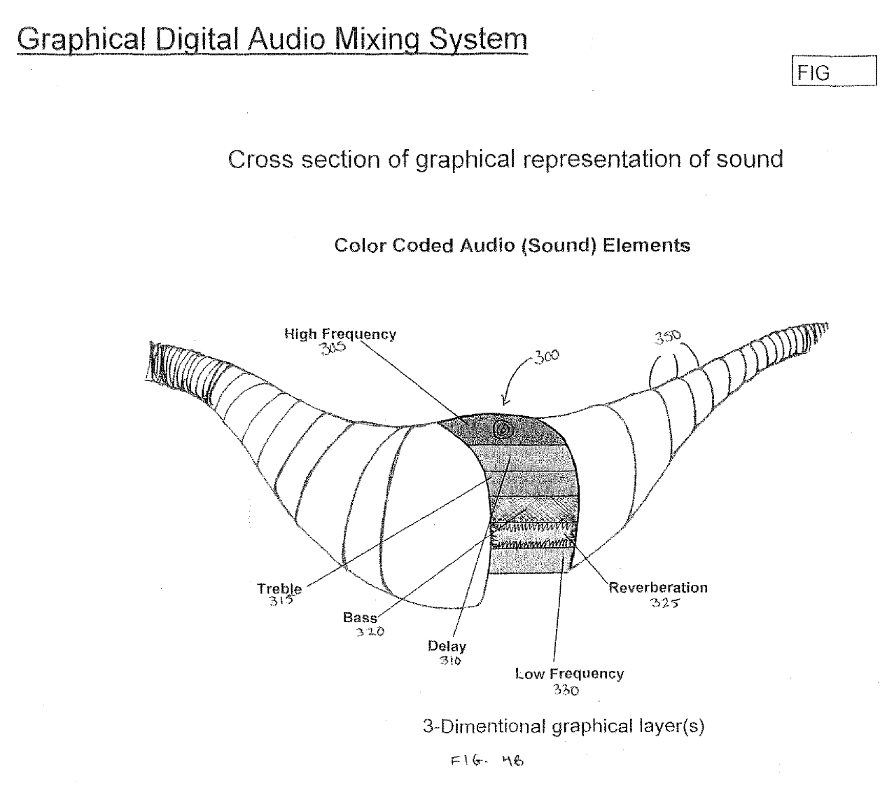

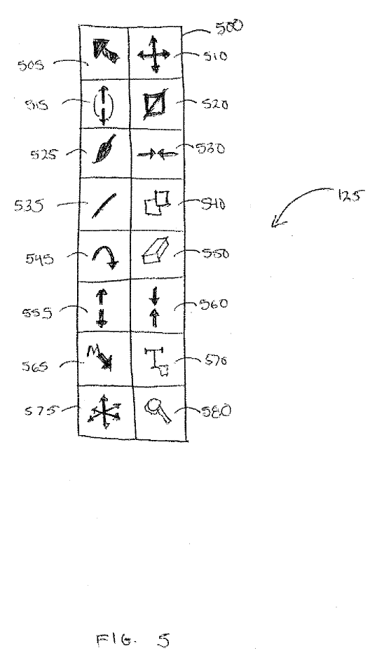

For example, the magnitude of each element 300 may be related to size. As illustrated in FIG. 4A, raising the volume level of a single element 300, such as high frequency 305, in relation to the other elements 300, may be indicated by expanding or increasing the size of that element 305. Similarly, an element 300, such as treble 315, may be decreased in relation to other elements 300, represented by a shrinking of the graphical representation of that element 315.

Further, as illustrated in FIG. 4B, each audio element 300 may be color coded so that additional audio properties of each element 300 may be manipulated. For example. raising the low end frequency on an element 300, such as bass 320, may deepen what had been a light yellow color to a dark yellow color. Further, for example, increasing the reverberation element 325 may cause the outer boundaries of the element 325 to become fuzzy, the magnitude of the reverberation being represented by the depth of the fuzziness toward the middle of the displayed element.

Other manipulations may be represented by graphical indicators such as concentric rings emanating from the middle of the element 300, with the rings becoming more pronounced as the level is increased. These are specific examples, but any visual representation, with any corresponding graphical impact in scale to the audio levels of the individual elements, is the foundation of the representation of the audio sculpting system.

Elements 300 may be manipulated to the full extent of the controls, at which point further manipulation of the image 120 is not allowed. If distortion or some other error condition is triggered by the manipulation, then the affected section of the track 350 experiencing error may be accordingly indicated, such as by flashing in the displayed image 120.

### Editing Tools

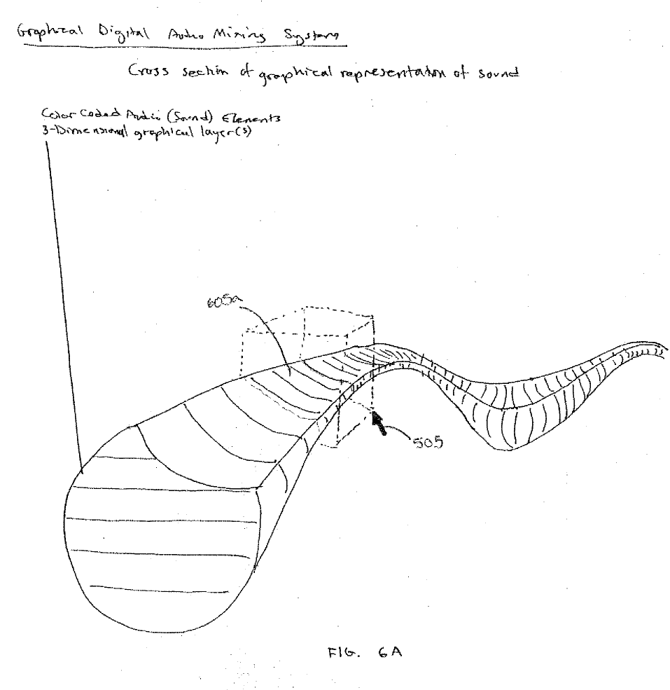

The graphical tools 125, as illustrated in FIG. 5, used to edit the audio elements 300, which may be CAD tools, mouse-held tools, touch screen tools, keyboard-based tools or virtual-reality-based tools, allow for areas and lines of demarcation of the displayed image 120 to be moved and expanded.

The tools 125 may be located on a toolbar 500 and may include: area selection 505, move 510, stretch 515, crop 520, slice 525, splice 530, line 535, clone 540, repeat 545, erase 550, expand 555, shrink 560, select manipulation 565, notes 570, move image 575 and zoom 580.

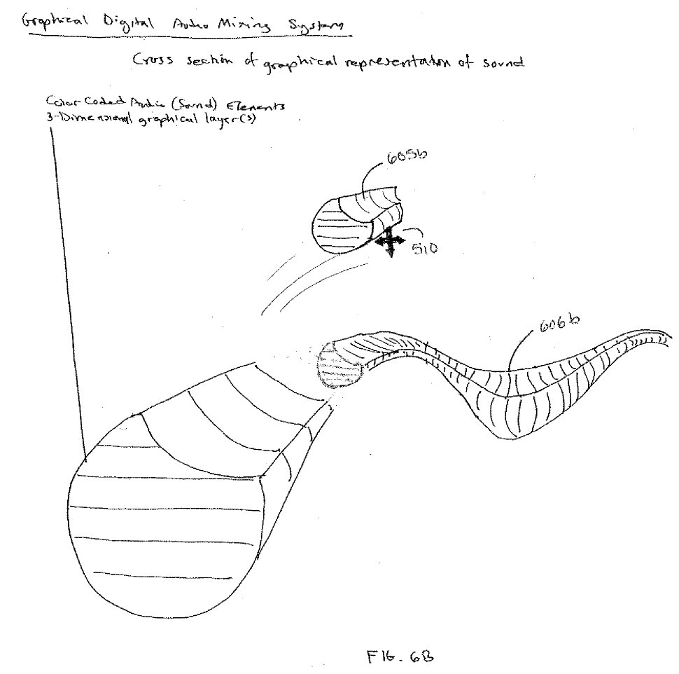

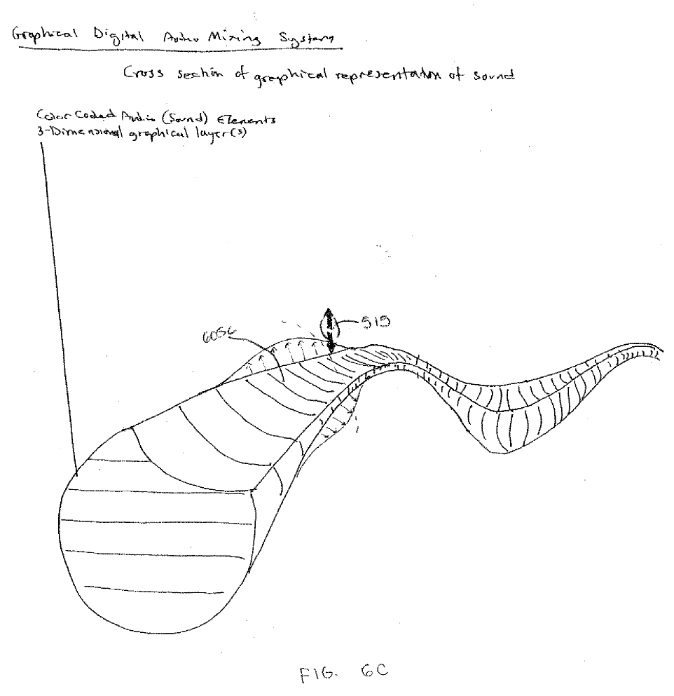

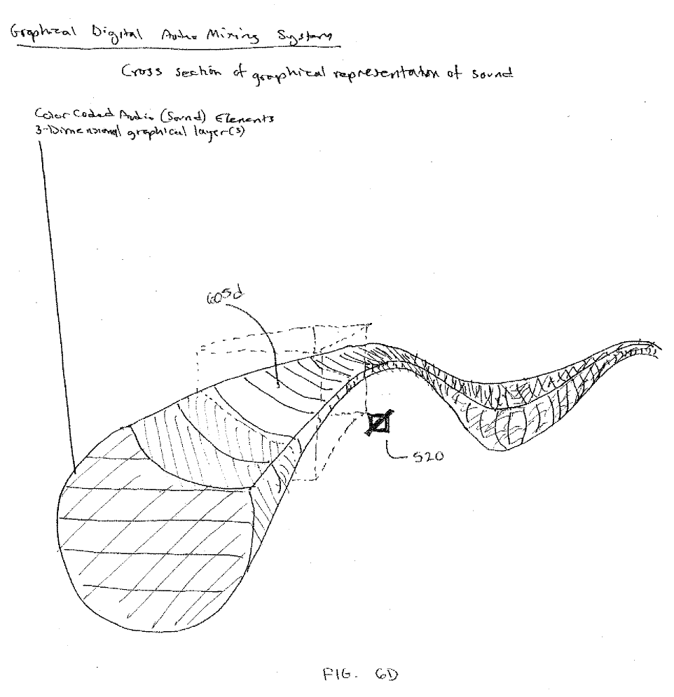

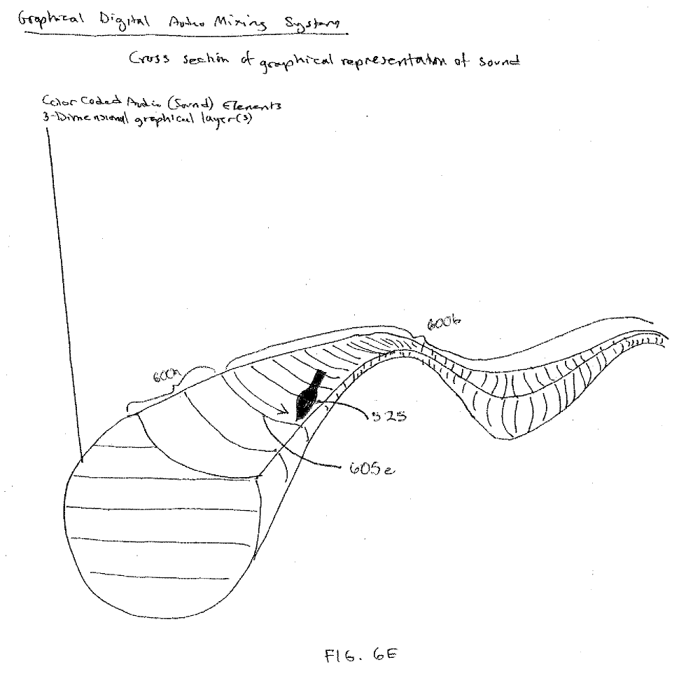

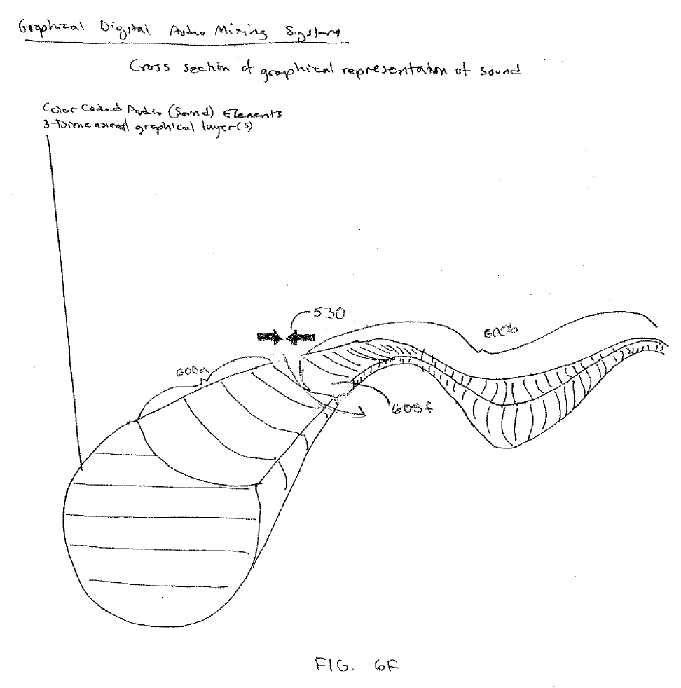

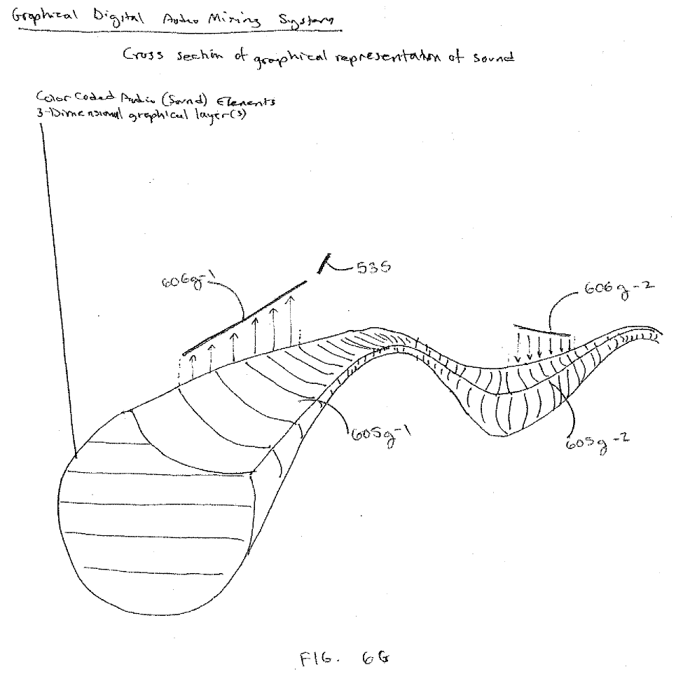

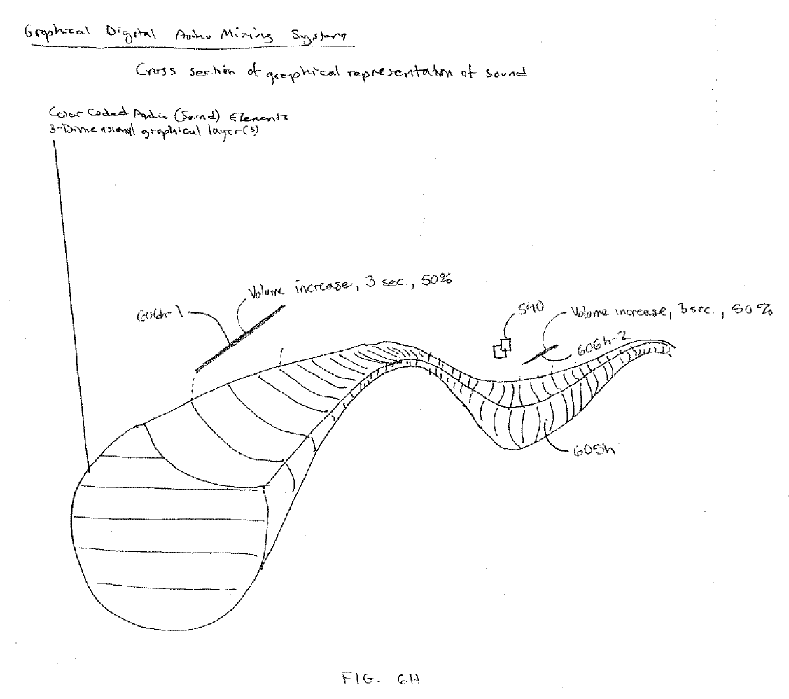

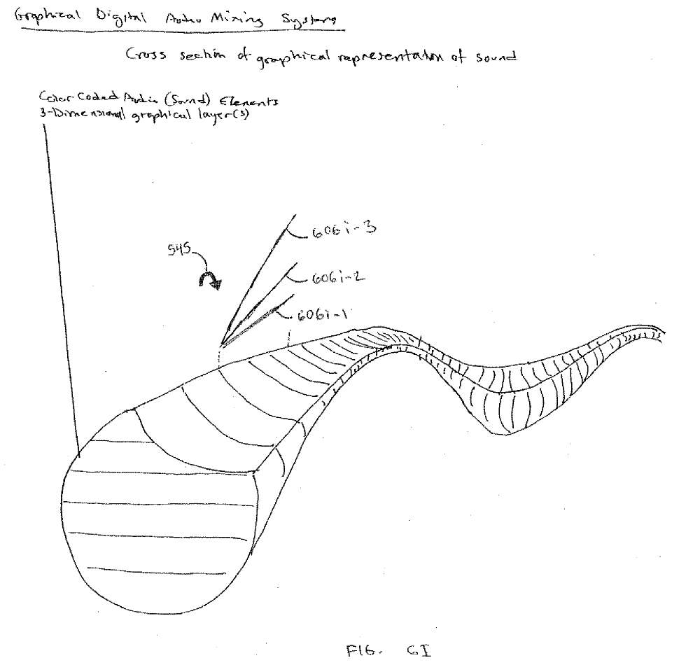

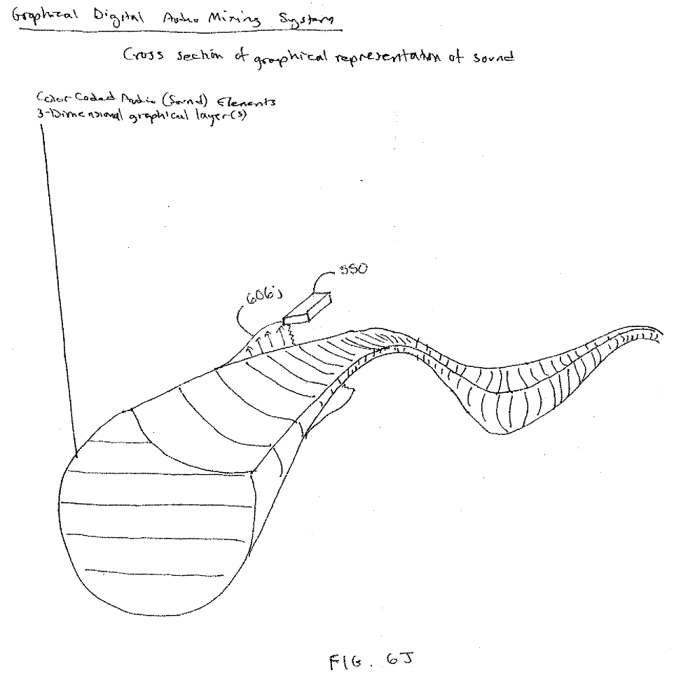

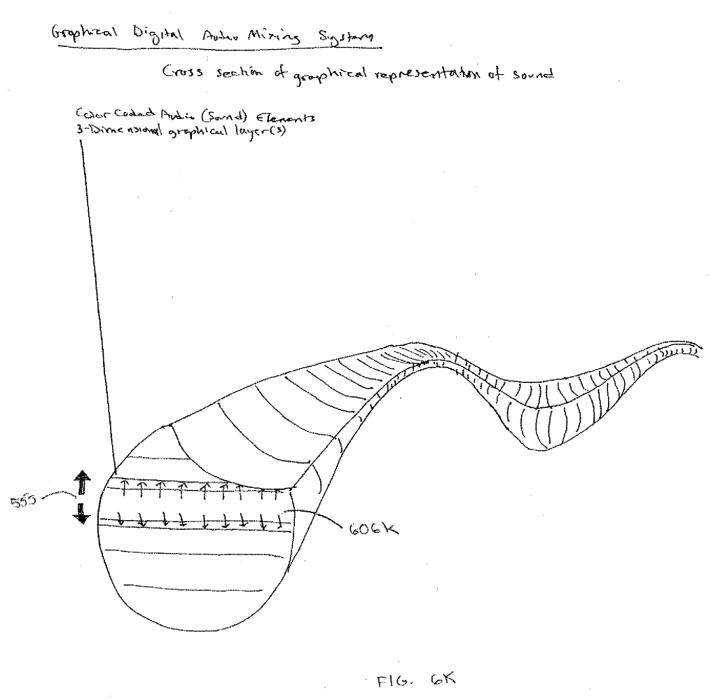

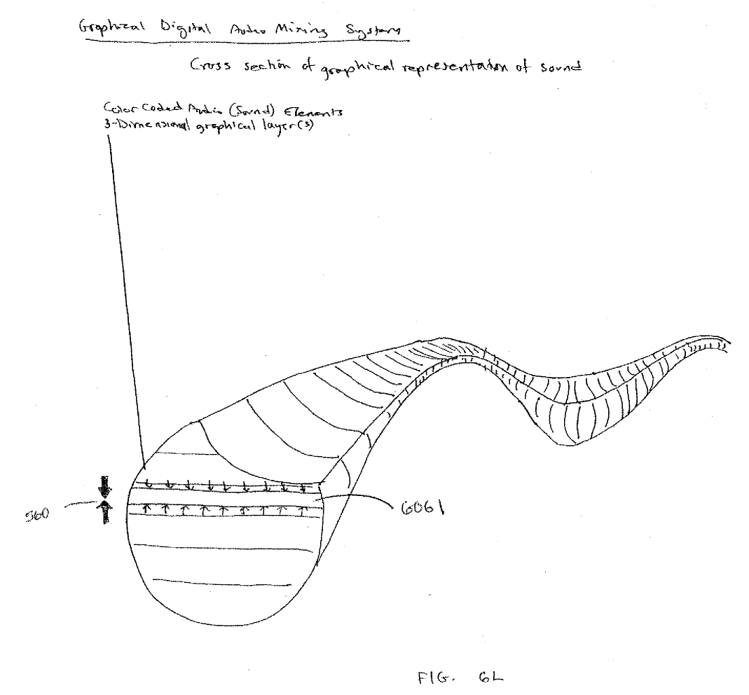

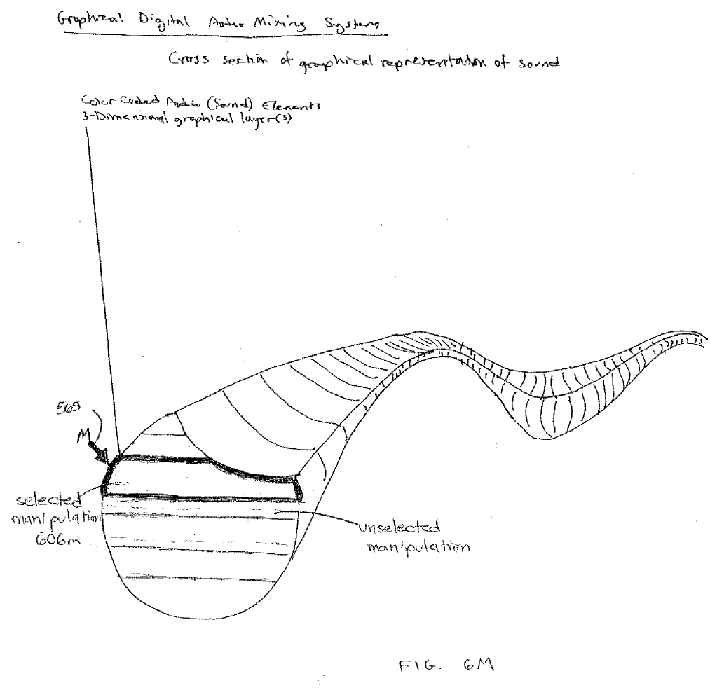

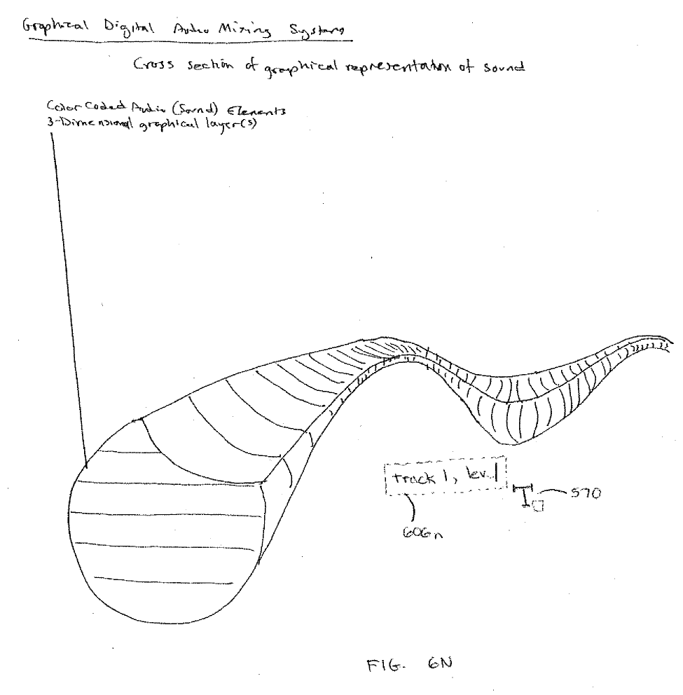

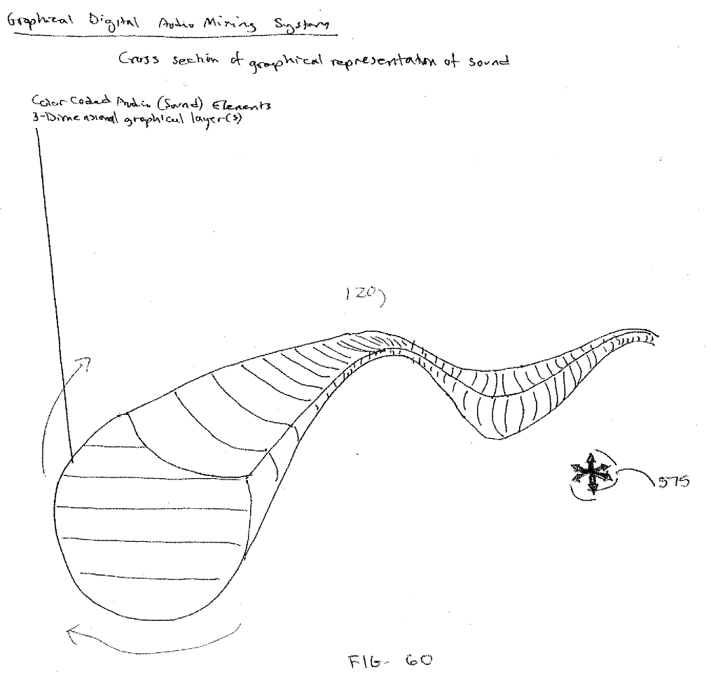

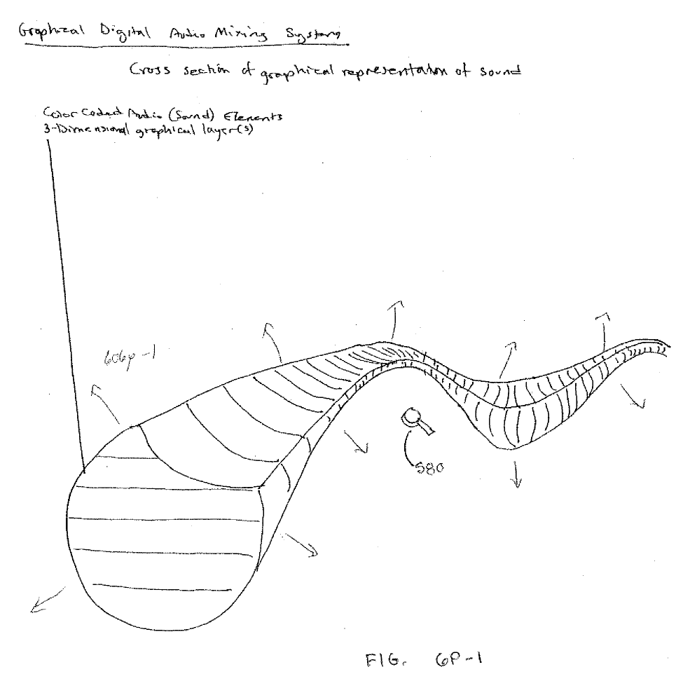

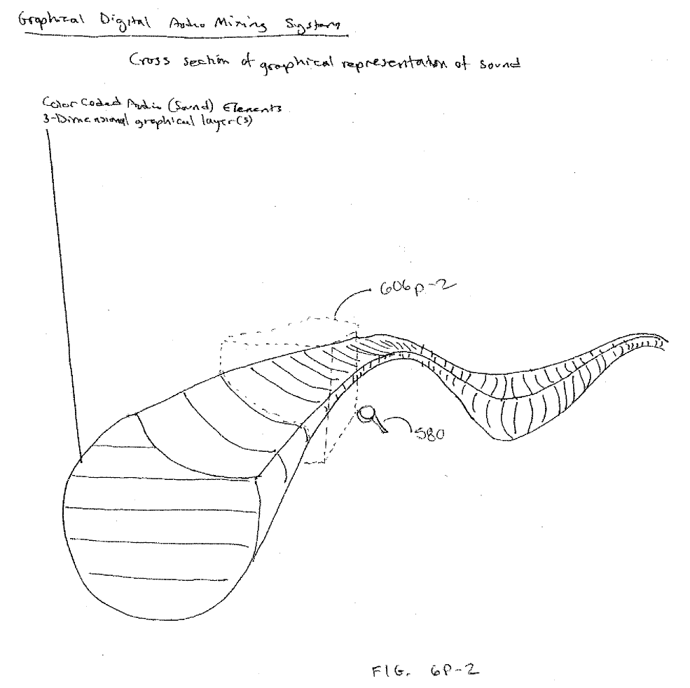

For example, FIGS. 6A-6P illustrate the use of the tools on the toolbar 500 of FIG. 5.

As illustrated in FIG. 6A, the user can select a portion of an audio element 300 by choosing the area select tool 505, clicking a mouse button and dragging the area select tool 505 over the desired area 605a.

As illustrated in FIG. 6B, the user can move a selected area 605b to another portion 606b of the image 120 by choosing the move tool 510, clicking a mouse button and dragging the selected area 605b to the desired location 606b.

As illustrated in FIG. 6C, the user can stretch the image 120 by selecting the stretch tool 515, clicking a mouse button and dragging the desired section 605c of the image 120.

As illustrated in FIG. 6D, the user can crop the image 120 by choosing the crop tool 520, clicking a mouse button and dragging the crop tool 520 over the desired section 605d of the image 120.

As illustrated in FIG. 6E, the user can slice the image 120 into two pieces 600a, 600b by choosing the slice tool 525, clicking a mouse button and dragging the slice tool 525 over the desired cut location 605e.

As illustrated in FIG. 6F, the user can splice two pieces 600a, 600b of the image 120 together by choosing the splice tool 530, clicking a mouse button and dragging the splice tool 530 over the effected ends 605f of the desired pieces 600a, 600b.

As illustrated in FIG. 6G, the user can adjust levels in a recording, such as volume, by selecting the line tool 535 and drawing a diagonal line indicating an increase 606g-1 or decrease 606g-2 in volume across a desired portion 605g-1, 605g-2 of the image 120.

As illustrated in FIG. 6H, the user can make a clone 606h-2 of a previously established manipulation 606h-1 by choosing the clone tool 540, clicking a mouse button over the desired manipulation 606h-1 and then clicking a mouse button over the desired location 605h of the cloned manipulation 606h-2.

As illustrated in FIG. 6I, the user can cause a manipulation 606i-1 to be applied repetitively 606i-2, 606i-3 by selecting the repeat tool 545 and clicking the previously applied manipulation 606i-1.

As illustrated in FIG. 6J, the user can erase a manipulation 606j by choosing the erase tool 550, clicking a mouse button and dragging the erase tool 550 over the desired manipulation 606j.

As illustrated in FIG. 6K, the user can expand an element 606k, thereby increasing the element 606k, by choosing the expand tool 555, clicking a mouse button and dragging the expand tool 555 over the desired portion 606k of the image 120.

As illustrated in FIG. 6L, the user can shrink an element 606l, thereby decreasing the element 606l, by choosing the shrink tool 560, clicking a mouse button and dragging the shrink tool 560 over the desired portion 606l of the image 120.

As illustrated in FIG. 6M, the user can select a manipulation 606m by choosing the select manipulation tool 565, and clicking a mouse button on the desired manipulation 606m.

As illustrated in FIG. 6N, the user can add text notes 606n to the image 120 by choosing the notes tool 570 and clicking a mouse button where the note 606n is desired.

As illustrated in FIG. 6O, the user can move the image 120 and change the perspective by choosing the move image tool 575, clicking a mouse button on the image 120 and moving the mouse to achieve the desired orientation or perspective.

As illustrated in FIG. 6P-1, the user can change the zoom level of the image 120 by selecting the zoom tool 580 and clicking a mouse button over a desired area 606p-1 to zoom in or out. Alternatively, as illustrated in FIG. 6P-2, the user may drag the zoom tool 580 over a desired area 606p-2 to zoom in on that area 606p-2 only.

### Saving Individual Edits

As the audio sculpting process progresses, users of the audio sculpting system may save sections of the sculpting edits, cut and paste elements of the edits, and set automated sculpting based upon a specific command. The manipulations of each edit may be saved as objects in an archive. The audio sculpting system 115 may also automatically save the edited processes and label them in a logical way, such as “bass track hi freq 10 second reduction.” The saving may also be customized by the user. If the manipulations of an edit are desired to be duplicated at another point in a recording, then the user may input that edit process at that point in the track.

While this invention has been particularly shown and described with references to example embodiments thereof, it will be understood by those skilled in the art that various changes in form and details may be made therein without departing from the scope of the invention encompassed by the appended claims.

What is claimed is:

1. An audio data editing system, comprising:
an audio data source;
a display;
at least one editing device for manipulation by a user for generating audio data editing signals; and
a processor to receive said signals from said device and audio data from said source, the processor generating a graphical image for the display, establishing a relationship between the audio data and the graphical image wherein the graphical image is a direct model of the audio data, responding to said data editing signals to select audio data elements, and manipulating the graphical image through user manipulation of the editing device, the manipulations of the graphical image directly affecting a change to the audio data through said relationship between the audio data and the graphical image.

2. The audio data editing system of claim 1, wherein the graphical image is generated on a one-to-one basis with the audio data.

3. The audio data editing system of claim 2, wherein the graphical image is a three-dimensional representation.

4. The audio data editing system of claim 1, wherein the graphical image encompasses one or more tracks.

5. The audio data editing system of claim 4, wherein the one or more tracks encompass one or more individual audio elements.

6. The audio editing system of claim 5, wherein audio element properties are represented as size, color, hue, saturation, fuzziness, or concentric rings.

7. The audio data editing system of claim 5, wherein manipulation of the graphical representation likewise manipulates all encompassed audio elements.

8. The audio data editing system of claim 1, wherein audio data is stored at the audio data source at the time of recording.

9. The audio data editing system of claim 1, wherein audio data is exported to the audio data source in advance of editing.

10. The audio data editing system of claim 1, wherein audio data is processed in real-time.

11. The audio data editing system of claim 1, wherein the editing device includes buttons, faders, dials and computer interface controls.

12. The audio data editing system of claim 1, wherein the processor generates the graphical image at a sampling rate of 48,000 hertz or higher.

13. The audio data editing system of claim 1, wherein the audio data is captured in units of time.

14. The audio editing system of claim 13, wherein the manipulation of audio elements in one or more tracks is synchronized.

15. The audio editing system of claim 14, wherein the Society of Motion Picture and Television Engineers time code is employed.

16. The audio editing system of claim 1, wherein manipulations are saved as objects in an archive.

17. The method of claim 1, wherein the graphical image is manipulated by user interaction with one or more graphical editing tools.

18. The method of claim 1, wherein the graphical image is manipulated by user interaction with traditional audio mixing technologies.

19. A method of editing audio data, comprising:
receiving audio data from a data source and audio data editing signals;
generating a graphical image representing the audio data;
establishing a relationship between the audio data and the graphical image representing the audio data wherein the graphical image is a direct model of the audio data;
responding to said data editing signals to select audio data elements; and
manipulating the graphical image through user manipulation, the manipulations of the graphical image directly affecting a change to the audio data through said relationship between the audio data and the graphical image.

20. The method of claim 19, further including generating the graphical image on a one-to-one basis with the audio data.

21. The method of claim 20, further including generating the graphical image as a three-dimensional representation.

22. The method of claim 19, further including the graphical image encompassing one or more tracks.

23. The method of claim 22, further including each one or more track encompassing one or more individual audio elements.

24. The method of claim 23, further including representing audio element properties as size, color, hue, saturation, fuzziness, or concentric rings.

25. The method of claim 23, wherein manipulation of the graphical image likewise manipulates all encompassed audio elements.

26. The method of claim 19, further including saving the audio data in graphical form at the time of recording.

27. The method of claim 19, further including exporting the audio data to the audio data source in advance of editing.

28. The method of claim 19, further including relating the audio data to the graphical image in real-time.

29. The method of claim 19, further including generating the graphical image at a sampling rate of 48,000 hertz or higher.

30. The method of claim 19, further including capturing the audio data in units of time.

31. The method of claim 30, further including synchronizing the manipulation of audio elements in one or more tracks.

32. The method of claim 31, further including employing the Society of Motion Picture and Television Engineers time code.

33. The method of claim 19, further including saving manipulations as objects in an archive.

34. The method of claim 19, further including manipulating the graphical image by user interaction with one or more graphical editing tools.

35. The method of claim 19, further including manipulating the graphical image by user interaction with traditional audio mixing technologies.

36. A computer readable medium containing instructions that, when executed, cause a machine to:
generate a graphical image from audio data;
establish a relationship between the audio data and the graphical image wherein the graphical image is a direct model of the audio data; and
respond to data editing signals to user selected audio data elements.
